(19) United States
(12) Patent Application Publication
(10) Pub. No.: US 2015/0347918 A1
(43) Pub. Date: Dec. 3, 2015

(54) FUTURE EVENT PREDICTION USING AUGMENTED CONDITIONAL RANDOM FIELD

(71) Applicants: Disney Enterprises, Inc., Burbank, CA (US); Queensland University of Technology, Brisbane (AU)

(72) Inventors: Patrick LUCEY, Burbank, CA (US); Xinyu WEI, Brisbane (AU)

(73) Assignees: Disney Enterprises, Inc., Burbank, CA (US); Queensland University of Technology, Brisbane (AU)

(21) Appl. No.: 14/294,000

(22) Filed: Jun. 2, 2014

(51) Int. Cl. G06N 5/04; G06N 99/00

(52) U.S. Cl. CPC G06N 5/048; G06N 99/005

(57) ABSTRACT

Systems and methods are disclosed for a future event prediction. Embodiments include capturing spatiotemporal data pertaining to activities, wherein the activities include a plurality of events, and employing an augmented-hidden-conditional-random-field (a-HCRF) predictor to generate a future event prediction based on a parameter-vector input, hidden states, and the spatiotemporal data. Methods therein utilize a graph including a first node associated with random variables corresponding to a future event state, a second node associated with random variables corresponding to spatiotemporal input data, a first group of nodes, each node therein associated with random variables corresponding to a subset of the spatiotemporal input data, a second group of nodes, each node therein associated with random variables corresponding to a hidden-state; wherein the edges connect the first node with the second node, the first node with the second group of nodes, and the first group of nodes with the second group of nodes.

### FIELD OF INVENTION

Embodiments of the present invention relate to methods and systems for predicting a future event based on spatiotemporal data.

### BACKGROUND OF INVENTION

The professional coverage of sporting events relies on extensive state-of-the-art technologies to provide unique experiences and better insights for viewers. Emerging technologies, including advance data capturing sensors and their calibration techniques, event recognition methods, and automatic detection and tracking systems, generate live raw data that are instrumental for processes that augment the broadcast video with instantaneous game-dependent graphics. These readily available raw data enable analyses that improve viewer understanding of live game developments and enrich coverage with contextual information about the players' and the teams' present and historical performances. Especially, knowledge of the teams' playing strategies and tactics is instrumental in capturing and covering their plays; the way a certain team interacts with another may be characterized and used to predict its future actions. Similarly, patterns of interactions among players may be learned and then used to predict a player's next moves and their outcome.

Being able to predict a player's future moves may be applicable to many tasks pertaining to delivering a live coverage of a sporting event. For example, applications for future event prediction may include allowing for informed camera steering or for providing supplementary information to commentators, coaches, or viewers with immediate highlights of the teams' maneuvers throughout the game. For instance, in a team-game that is focused on the whereabouts of the ball (or any other playing object such as the puck in a hockey game) knowing who might be the next player to own or handle the ball may be useful in improving automatic tracking of game participants. Likewise, in a tennis game, predicting the next shot's location may facilitate live predictive analyses. Other application domains that include observations of elements that interact with each other according to some pattern may also benefit from future event prediction. For example, surveillance systems monitoring people's movements, gestures, or communications may benefit from prediction of their future actions.

Probabilistic estimation methods utilize the statistical dependency among a problem domain's random variables to estimate (or classify) a subset of random variables based on another. Specifically, structured classification models use statistical dependency to label state variables based on other states and observed (i.e. input measurements) variables. Such structured classification models may be represented by a graph wherein random variables (i.e. state variables or observation variables) are assigned to the graph's nodes and the graph's edges denote an assumed statistical dependency among the variables assigned to those nodes. Typically, in a multivariate estimation problem the objective is to estimate the value of state vector y based on observation vector x. The optimal approach for solving this involves modeling the Joint Probability Distribution Function (j-PDF) p(y,x). However, constructing a j-PDF over y and x may lead to intractable formulations, especially in cases where vector x is of high dimensionality and includes complex inter-dependencies. One way to reduce such complexity is to assume statistical independence among subsets of model variables. This allows factorization of the j-PDF into products of local functions. As will be shown below, graphical modeling is helpful in depicting an assumed factorization of p(y,x).

A graph may be constructed to represent a sequence of state variables y and their associated observation variables x where the goal is, for example, to label (classify) the state variables based on the observation variables. For instance, Hidden Markov Models (HMM) have often been used to label variables in segmentation tasks. An HMM includes states y={yⱼ}ⱼ₌₁^{m} and associated observations x={xⱼ}=ⱼ₌^{m} where an observation vector xⱼ includes any observable (measurable) data that may influence any of the problem defined state variables yⱼ. To reduce the complexity of naive HMM joint distribution modeling, it is assumed 1) that each state yⱼ depends only on its immediate predecessor state yⱼ₋₁ and 2) that each observation xi depends only on the corresponding state yⱼ. These assumptions lead to the following factorization of the j-PDF:

$$p ( y , x ) = {\prod }_{j = 1}^{m} p ( {γ}_{j} \vert {γ}_{j - 1} ) p ( \text{?} {x}_{j} \vert {γ}_{j} ) \\ \text{?} \text{indicates text missing or illegible when filed} \qquad ( 1 )$$

A graphical description of this factorization is shown in FIG. 1A where an HMM of order m is defined by a directed graph 100. Notice that the factor p(yⱼ|yⱼ₋₁) is consistent with the graph's edge that connects yⱼ with yⱼ₋₁ and that the factor [symbol] p(x [symbol] ⱼ|yⱼ) is consistent with the graph's edge that connects xⱼ with yⱼ. Although tractability has improved in (1), the level of this model's performance depends on the validity of the assumptions above with respect to the application domain.

In general, to classify or label y based on the given observations in x, the conditional distribution function p(y|x) (i.e. the posterior probability) is required. Given the HMM modeling of the joint distribution in (1), the conditional distribution p(y|j) may be calculated out of p(y,x) using Baye's rule. Note that the HMM model is considered in the art as a generative model: p(xⱼ|yⱼ) describes how a label yⱼ statistically “generates” a feature vector xⱼ. An alternative approach is a discriminative model wherein the conditional probability p(y|x) is modeled directly. A popular discriminative model is Conditional Random Field (CRF). A CRF model is not complicated by complex dependencies that involve variables in x. Thus, the expression for the conditional probability is simpler than that for the joint probability model HMM. CRF-based models are better suited when a larger and overlapping set of observation variables are required to closely approximate the problem domain.

CRF models differ based on the way the conditional distribution p(y|x) is factored. For example, yⱼ may be influenced by (or statistically dependent on) yⱼ₋₁, xⱼ₋₁, xⱼ, and xⱼ₊₁. Alternatively, in a linear-chain CRF, yⱼ assumed to be influenced merely by yⱼ₋₁ and xⱼ, as demonstrated by the undirected graph 110 in FIG. 1B. Formally, a linear-chain CRF is defined as follows. Given the random vectors x and y, parameter vector θ={θₖ}εR^{K}, and real valued feature-functions F={fₖ}ₖ₌₁^{K}, a linear-chain CRF is the distribution p(y|x) that is modeled by:

$$p ( y , x ) ≡ p ( y \vert x ; θ ) = \frac{{e}^{Ψ ( y , x ; θ )}}{{\sum }_{y}^{{ }^{′}} {e}^{Ψ ( {y}^{′} , x ; θ )}} , \qquad ( 2 )$$

where Ψ(y,x; θ)ε [symbol] is a potential function parameterized by θ:

$$Ψ ( y , x ; θ ) ≡ {\sum }_{j = 1}^{m} {\sum }_{k = 1}^{K} {θ}_{k} {f}_{k} ( {γ}_{j} , {γ}_{j - 1} , {x}_{j} ) . \qquad ( 3 )$$

CRFs were introduced by Lafferty et al. (see Conditional random field: probabilistic models for segmenting and labeling sequence data, ICML-2001). CRFs have since been widely used for various applications such as tracking, image segmentation, and activity/object recognition. As mentioned above, to maintain tractability, HMM assumes inter-independency among observation variables. In contrast, CRF, by virtue of directly modeling the conditional distribution function, allows for direct interactions among the observation variables. CRF is limited by the assumption of Markovian behavior (i.e. a state depends only on its previous state), but this limitation is relaxed by a high-order CRF where a state may depend on several previous states. Nonetheless, in a CRF model, the parameter vector θ is optimized to estimate the most likely sequence y based on the given x, while in a prediction problem what is required is to estimate the most likely future state yⱼ₊₁ based on [symbol] {y [symbol] ⱼ, yⱼ₋₁, . . . yⱼ₋ₘ₊₁} and x. As will be explained below, this problem may be solved by defining the states [symbol] {y [symbol] ⱼ,yⱼ₋₁, . . . yⱼ₋ₘ₊₁} as hidden-states and optimizing for only yⱼ₊₁.

Generally, models that include hidden-state structures provide more flexibility in representing the problem domain relative to fully observable models (e.g. CRF). Hence, a Hidden-state Conditional Random Field (HCRF) model was proposed by Quattoni et al. where intermediate variables are used to model the latent structure of the problem domain (see “Hidden state conditional random fields” in PAMI, 2007). FIG. 1C shows an undirected graph of an HCRF model 120. The HCRF graph represents a joint probability over the class label yⱼ₊₁ and the hidden state labels h, conditioned on observations x. Thus, yⱼ₊₁ (also referred to herein as y) is the state variable for which a labeling is pursued.

$$x = {\{ {x}_{j} \}}_{j = 1}^{m}$$

is the vector of local observations. The hidden states are represented by

$$h = {\{ {h}_{j} \}}_{j = 1}^{m} .$$

Each hⱼ may take a value out of a set of values [symbol] . The HCRF model is defined as follows:

$$p ( y \vert x ; θ ) ≡ {\sum }_{h} p ( y , h \vert x ; θ ) = \frac{{\sum }_{h ∈ H} {e}^{Ψ ( y , h , x ; θ )}}{{\sum }_{{y}^{′} ∈ y , h ∈ ℋ} {e}^{Ψ ( {y}^{′} , h , x ; θ )}} \qquad ( 4 )$$

where the potential function in this model may be:

$$Ψ ( y , h , x ; θ ) ≡ {\sum }_{j = 1}^{m} [ {\sum }_{{k}_{1} = 1}^{{K}_{1}} {θ}_{{k}_{1}} {f}_{{k}_{1}} ( y , {h}_{j} ) + {\sum }_{{k}_{2} = 1}^{{K}_{2}} {θ}_{{k}_{2}} {f}_{{k}_{2}} ( {h}_{j - 1} , {h}_{j} , {x}_{j} ) ] . \qquad ( 5 )$$

The model parameter vector θ is computed in a training process wherein a training dataset, including labeled examples

$${{\{ 〚 ) y 〛}_{i} , {x}_{i} ) \}}_{i = 1}^{n} ,$$

is used to estimate the parameter vector utilizing an objective function such as

$$ℒ ( θ ) = {\sum }_{i = 1}^{n} log p ( {y}_{i} \vert {x}_{i} ; θ ) - \frac{1}{2 {σ}^{2}} {\vert θ \vert}^{2} , \qquad ( 6 )$$

where log p(yᵢ|xᵢ; θ) is the log-likelihood of the data and

$$\frac{{‖ θ ‖}^{2}}{2 {σ}^{2}}$$

is the log of Gaussian prior over θ. The optimal parameter vector θ*is derived by maximizing £(θ):

$${θ}^{↑} *= arg {max}_{↓} θℒ ( θ ) . \qquad ( 7 )$$

Known-in-the-art optimization methods may be used to search for θ [symbol] (e.g. gradient ascent based methods). In cases where the objective function is not convex, global searching schemes are typically applied to prevent the search from getting trapped in a local maximum.

Hence, a classification task of labeling the event y generally comprises a learning phase and a testing-phase. The learning phase is typically accomplished offline and, as explained above, is directed at finding the optimal parameter vector θ [symbol] based on any suitable objective function such as (6). Having the optimal parameter vector, the classifier is operative and ready for labeling in the subsequent testing-phase. In the testing-phase, given an input x (out of a testing dataset) and the optimal parameter vector θ [symbol] , the label of event y is estimated by y [symbol] as follows:

$${y}^{*} = {max}_{y ∈ 𝓎} p ( y \vert x ; {θ}^{*} ) . \qquad ( 8 )$$

The computation of y [symbol] , referred to as inference in the art, results in the labeling of event y. The accuracy of this labeling depends, in part, on how well the training dataset is representative of the testing dataset.

An HCRF model introduces improvement with respect to a basic CRF model as it optimizes yⱼ₊₁ directly and allows statistical dependency between yⱼ₊₁ and previous states (high-order CRF). However, yⱼ₊₁ is assumed not to be directly influenced by the observations x={xⱼ}ⱼ₌₁^{m} (they are not edge-connected in the HCRF graph 120). Depending on the problem domain, event yⱼ₊₁ may be influenced by local observations xⱼ captured within the temporal neighborhood of tⱼ as well as by relatively more global observations. Especially in today's advanced and accessible capturing technologies, rich spatiotemporal data may be collected and readily available for processing by efficient computing systems. Future events are likely to be statistically dependent on these spatiotemporal data, and, therefore, these data predictive capability should be leveraged. Systems and methods that directly model the influence that observed spatiotemporal data have on future events are needed.

Known in the art methods have employed HMMs and CRFs for controlling autonomous cars and for Neuro-Linguistic Programming (NLP) pattern recognition, for instance. In these application domains the problem space can be formulated into states that may be reliably labeled by a human to form a training dataset. As these are cooperative environments, they give rise to predictable outcomes. For example, in controlling autonomous cars the behavior of pedestrians is foreseeable (e.g. people tend to stand at the street corner while waiting for the lights to change). Likewise, in NLP, sentences are expected to consist of sentence-parts (e.g. nouns, verbs, etc.). Therefore, in these domains reliable labelling of a model's states in the training phase may be achieved and future behavior may be approximated by a Markovian assumption.

On the other hand, sporting events are non-cooperative environments. Players in a team-game exhibit continuous and adversarial behavior, and, therefore, labeling game states may be a more difficult task. Moreover, predicting future behavior is complex, as interactions among multiple factors require modeling longer term dependencies. As mentioned above, HCRF and high-order CRF models have been introduced to counter this complexity, where a-priori knowledge of the hidden-states is not required and longer-term dependencies can be incorporated, respectively. Accordingly, in the HCRF model prediction is done based on the hidden-states. This allows for capturing contextual information about the future event. To further improve prediction accuracy in a dynamic environment, such as a team-game, methods that directly condition the final prediction on the input observations as well as on the hidden states are required.

### BRIEF DESCRIPTION OF THE DRAWINGS

Embodiments of the invention are described with reference to the accompanying drawings.

FIG. 1A shows a prior art graph, depicting a structured model of type HMM.

FIG. 1B shows a prior art graph, depicting a structured model of type CRF.

FIG. 1C shows a prior art graph, depicting a structured model of type HCRF.

FIG. 2 shows a graph depicting a new structured model, namely Augmented Hidden-states Conditional Random Field (a-HCRF).

FIG. 3 illustrates a soccer field and players' movements on the field.

FIG. 4 shows an exemplary embodiment of the present invention featuring a future event prediction system.

FIG. 5 shows a flowchart illustrating the training process according to one embodiment of the present disclosure.

FIG. 6 shows a flowchart illustrating the testing process according to one embodiment of the present disclosure.

FIG. 7A illustrates an example of future ball possession prediction according to one embodiment of the present disclosure.

FIG. 7B illustrates another example of future ball possession prediction according to one embodiment of the present disclosure.

FIG. 8A illustrates tennis shot prediction using various features according to one embodiment of the present disclosure.

FIG. 8B illustrates one possible quantization scheme for tennis shot prediction according to one embodiment of the present disclosure.

FIG. 9 shows a flowchart illustrating the process of tennis shot prediction according to one embodiment of the present disclosure.

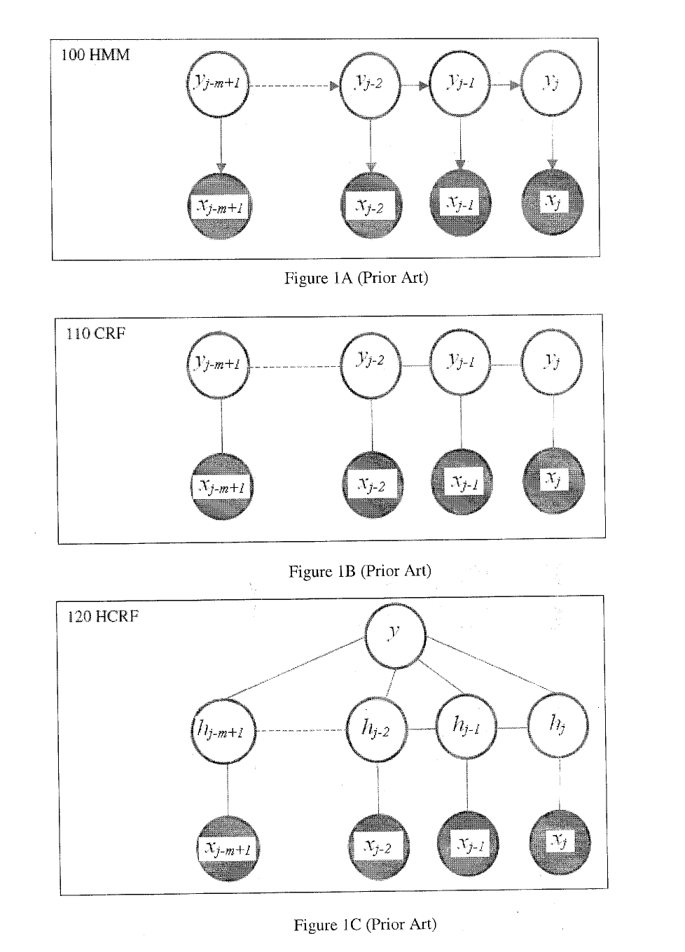

### DETAILED DESCRIPTION

Methods and systems for predicting a future event are provided. Embodiments of the invention disclosed herein describe future event prediction in the context of predicting the future owner of the ball in a soccer game as well as predicting the future location of the next shot in a tennis game. While particular application domains are used to describe aspects of this invention, it should be understood that the invention is not limited thereto. Those skilled in the art with access to the teachings provided herein will recognize additional modifications, applications, and embodiments within the scope thereof and additional fields in which the invention would be of significant utility.

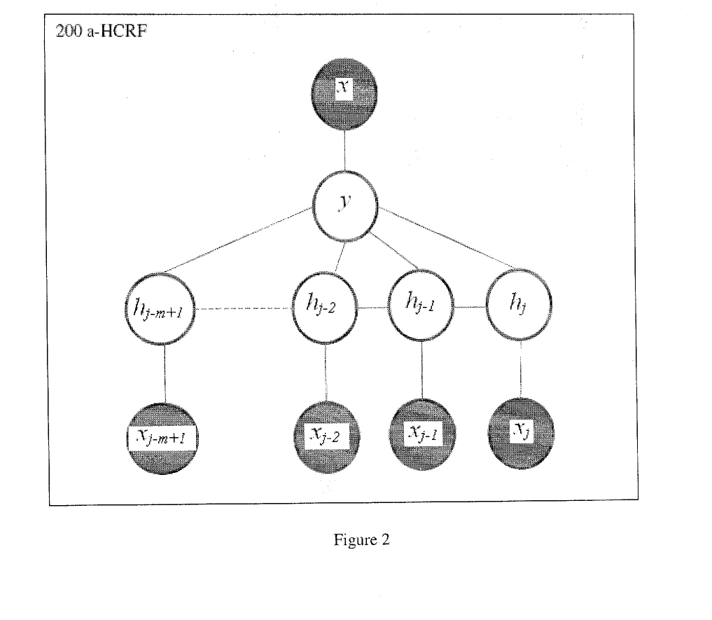

A new model is presented herein, namely Augmented Hidden-states Conditional Random Field (a-HCRF), that may be used for the prediction of a future event. The a-HCRF is a discriminative classifier that leverages on the assumed direct interaction between a future event and observed spatiotemporal data measured at a time segment prior to the predicted event. Current and past states' influence on the future event are also factored into the proposed a-HCRF model. FIG. 2 shows an undirected graph depicting the proposed a-HCRF model factorization, referred to herein also as the a-HCRF predictor. The graph topology defines the direct influence between y (i.e. yⱼ₊₁) and both the observations x and the hidden states h, as will be further explained below. Embodiments of this invention, therefore, utilize the a-HCRF model to label a future event (i.e. estimate the value of the random variable y) based on the statistical dependency it embodies with current and past hidden states (i.e. h) and associated observations (i.e. x).

The a-HCRF model disclosed herein is described in the context of labeling a future event (e.g. labeling ball possession in a soccer game and shot location in a tennis game) based on a temporal series of hidden states and associated observation measurements. A person skilled in the art will appreciate that other applications of the a-HCRF model to other problem domains may be used without departing from the spirit and scope of this invention's embodiments. For example, a-HCRF may include hidden states that are corresponding to points in time that are ahead of the “future event” or hidden states that may correspond to points in spaces other than time.

In an embodiment, the goal may be to classify a future event y; meaning to assign the most likely label to y, out of a set of possible labels y, based on both a series of current and historical events h={hⱼ}ⱼ₌₁^{m} and given corresponding observations x={xⱼ}ⱼ₌₁^{m}. hⱼ may share the same set of labels with y (i.e hⱼ εy) or assumes membership of another set of labels (i.e hⱼ εy) depending on the application domain. An observation xⱼ may include any measurements such as an image or a sequence of video-frames. Typically, an observation is represented by a feature vector

$$〚 ϕ ( x 〛 ) ∈ {ℛ}^{d}$$

that compactly characterizes the raw observation data. For example, xⱼ may be representing a local observation such as a video-frame that was captured at time tⱼ. In this case, the feature-vector

$$[ ( {ϕ ( x ]}_{j} )$$

may include positional data of objects (e.g. players/ball) as well as any descriptors that may be extracted from objects' image in the video frame. These descriptors may measure texture, color, and shape from which further information may be deducted such as the objects' identity. Notice that the feature-vector extracted from x also may include information that is more global in nature. For example, the most recent soccer game phase (e.g. passes, shots, free-kicks, corners, substitutions, etc.).

Similar to HCRF, the posterior of the a-HCRF model may be specified by the expression in (4). The difference is in the formulation of the a-HCRF model's potential function Ψ(y,h,x; θ):

$$Ψ ( y , h , x ; θ ) ≡ {\sum }_{j = 1}^{m} ϕ ( x , j , ω ) \cdot {θ}_{h} [ {h}_{j} ] + {\sum }_{j = 1}^{m} {θ}_{y} [ y , {h}_{j} ] ++ {\sum }_{( j , k ) ∈ s} {θ}_{s} [ y , {h}_{j} , {h}_{k} ] + \frac{ϕ ( x , ω ) \cdot {θ}_{p} [ y ]}{k} . \qquad ( 9 )$$

Thus, φ(x,j,ω) is a feature-vector computed based on the observation xⱼ, including measurements that were recorded within a time window ω relative to tⱼ. The a-HCRF model's parameters includes: 1) parameters θₖ associated with the hidden states hⱼ, 2) parameters θ_{y} associated with event y and the hidden states hⱼ, 3) parameters θₒ associated with event y and a pair of edge-connected states hⱼ and hₖ, and 4) parameters θₚ associated with event y given all observations x. Jointly, the model parameter-vector includes

$$[ θ = {[ θ ]}_{h} , {θ}_{y} , {θ}_{e} , {θ}_{p} ] .$$

It is apparent that the terms in (9) correspond to a factorization that is consistent with graph 200. Each term measures the joint compatibility of variables that are assigned to nodes connected by edges. The first term φ(x,j,ω)·θₕ[hⱼ] reflects the compatibility between hidden state hⱼ and observation xⱼ. The second term θ_{y}[y·hⱼ] reflects the compatibility between event y and hidden state hⱼ, while the third term θ [symbol] [y,hⱼ,hₖ] reflects the compatibility between event y and a pair of connected hidden states hⱼ and hₖ. The last term (φ(x,ω)·θₚ[y]/k reflects the compatibility between all the observations and event y, where k denotes the number of possible combinations of h.

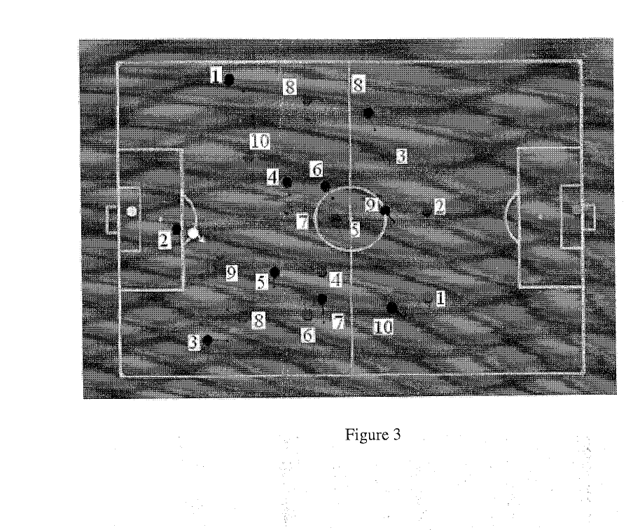

Exemplary embodiments of this invention utilize the a-HCRF model to perform prediction of future game-events, such as what player will next own the ball in a team-game such as soccer. FIG. 3 shows a graphical representation of a soccer field, denoting the positions and the motion orientations of the players from team-A and from team-B. Being an adversarial game, a team moves in various formations depending on the current play (e.g. offensive or defensive) and in response to the opposing team's movements. Typically, each team has characteristic playing styles (employed strategies and tactics) that are influenced by the opposing team's playing behavior. This interaction (dependency) among the players' actions and among the game's unfolding events is what allows probabilistic prediction of one action (event) based on the other actions (events) and observed game data.

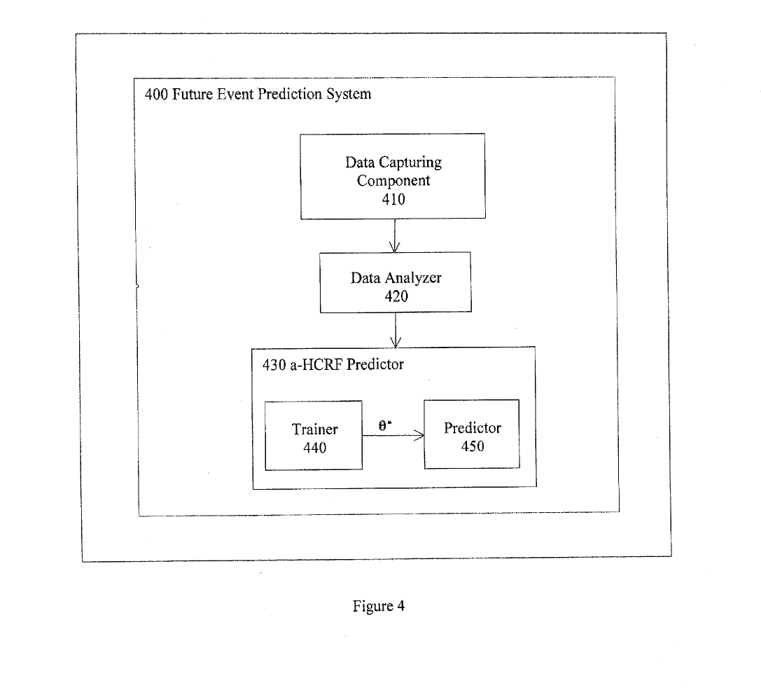

FIG. 4 shows a top level future event prediction system 400. The system's data capturing component 410 includes any means of measuring sensory data (i.e. observations). For example, covering a sporting event, the capturing system component may include video cameras, 3D scanners, microphones, real-time localization systems, etc. The measured observations (raw data) are fed into a data analyzer 420 for buffering and further processing. The data analyzer mainly extracts feature-vectors from the received raw data. Various features, characteristic of the game, participating elements, or teams may be extracted. For example, the players' and the ball's positional and motion data may be computed by known-in-the-art automatic tracking methods. Players' team identity, for example, may be recognized based on their jersey numbers and uniforms using color and shape descriptors extracted from their image projection in the video. Game-events such as passes, shots, free-kicks, corners, and substitutions may also be recognized by analyzing the players' formations on the field. This feature extraction operation, denoted above by φ(•), results in a feature-vector that may be, in part or as a whole, internal to embodiments of this invention (generated by the data analyzer 420) or externally provided as an input. Feature-vectors derived from several games are paired with a corresponding labeled event y and used for training. The trainer 440 then provides the predictor 450 with the optimal estimate for the parameter-vector θ [symbol] based on the given training dataset. Given the parameter-vector, the predictor is ready for online operation, wherein it operates in its testing mode. Generally, the trainer's 440 operation is prior to the predictor's 450 operation, as the former provides the latter with the necessary parameter-vector θ [symbol] .

Hence, according to an embodiment and in reference to the a-HCRF graph 200, the hidden state hⱼ is defined as the owner of the ball at time tⱼ. Similarly, the hidden state hⱼ₋₁ is defined as the owner of the ball at a point in time previous to tⱼ, denoted by tⱼ₋₁. The predicted event y is defined as the “future ball owner” at time t_{⊥}(j+1) (after tⱼ). The time steps between two successive states, tⱼ₋₁ and tⱼ may vary, depending on the application, in the magnitude order of seconds. xⱼ to xⱼ₋ₘ₊₁ in graph 200 represent the observations, and, by extension, the feature-vectors φ(x,j,ω) derived from them. Features may be extracted from data captured during a window time ω. For example, φ(x,j,ω) may represent a feature-vector that was extracted from video frames captured in a time window between tⱼ and t_{j-ω}.

As mention above, the potential function comprises of products of factor functions consistent with the model's graph topology 200. Each factor function is indicative of an influence (or statistical dependency) among the participating variables (i.e. state and observation variables) it includes. In the context of predicting ball possession and with reference to (9), for example, the pairwise potential θ [symbol] [y,hⱼ,hₖ] may measure the tactics used in a team's passing pattern (e.g. the frequency in which a certain player passes the ball to another certain player). The potential φ(x,j,ω)·θₕ[hⱼ] may measure the compatibility between a certain player and a set of features. Therefore, in embodiments of this invention, a future event y (i.e. a future owner of the ball) is influenced by previous ownerships of the ball and by observation data captured in past or current times.

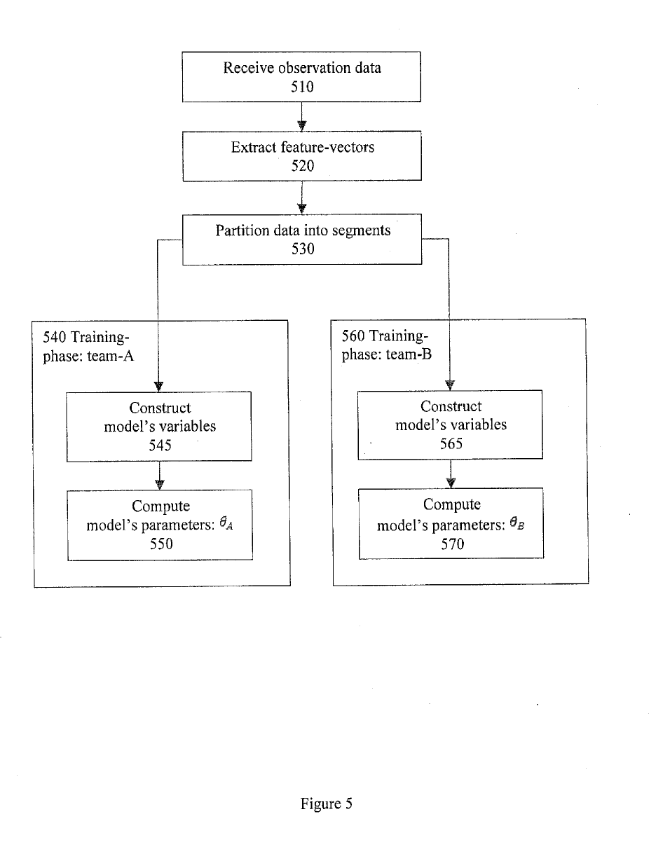

Prior to employing the prediction method, the parameters of the a-HCRF predictor need to be estimated in a process known as training. FIG. 5 shows the steps that are typically carried out during a training-phase. First, in step 510, observation data collected by the data capturing component 410 are received. As mentioned above those raw data may include spatiotemporal information indicative of the covered game unfolding events. Next, in step 520 features are extracted from those raw data by the data analyzer 420. Then, in step 530, time dependent data (i.e. raw data and related features) are partitioned into segments of continuous plays and stoppages, since the a-HCRF predictor is employed on continuous play segments, as will be explained further below. This partition may be achieved based on external information or may be determined internally. The latter may be accomplished by known-in-the-art methods for temporal video segmentation, for instance, by employing a random-forest classifier using as input the players' motion data or cues from event-originated audio.

According to embodiments of this invention, a continuous segment of time wherein events (represented by the hidden states) are unfolded is utilized. When employed for predicting the future owner of the ball in a soccer game, a continuous segment of time wherein a team is in possession of the ball precedes the prediction of that team's upcoming (future) passing of the ball. Assuming that the a-HCRF model includes m states, as depicted in graph 200, and that δtⱼ≡tⱼ−tⱼ₋₁, the length of this continuous segment may in general be S=δtⱼ+δtⱼ₋₁+δtⱼ₋₂+ . . . +δtⱼ₋ₘ₊₁ seconds or S=m·δt seconds when δt=δtⱼ. Hence, training of team-A's model 540 or team-B's model 560 is done based on training data extracted from continuous segments in which the ball is in team-A's possession or in team-B's possession, respectively.

Consequently, in FIG. 5, training is carried out for each team separately resulting in an a-HCRF model of team-A (i.e. parameter vector θ_{A}) and an a-HCRF model of team-B (i.e. parameter-vector θ_{B}) in steps 540 and 560, respectively. For each team, the a-HCRF model's variables are constructed in steps 545 and 565 resulting in team-A's training dataset and team-B's training dataset, respectively. Constructing the model's variables of team-A 545, for instance, may involve the following actions. The hidden states are defined as variables that can take one of eleven possible values, each representing a state in which one of team-A's eleven players is in possession of the ball. Hence, hⱼεK where K={Pᵢ^{A}}ᵢ₌₁¹¹. Similarly, the future event y is defined as a variable that can take one of twelve possible values. The first eleven values are the possible events where the ball is passed to a certain player from team-A. The twelfth event indicates a possible event in which the ball is passed to the other team (i.e. team-B), labeled as turn-over (TO) event. Hence, yεy where y={{Pᵢ^{A}}ᵢ₌₁¹¹,TO}. Next, the time difference, δtⱼ, between successive nodes in graph 200 may be determined. For example, two seconds may be selected to be the time difference between any tⱼ₋₁ and tⱼ, thus δtⱼ=δt=2 sec. Relative to these points in time the feature-vectors φ(x,j,ω) are constructed based on observations captured within a ω time window. For example, the feature-vector xⱼ may include features derived from raw data associated with a time window ω that expands between tⱼ and tⱼ−ω. Additionally, the vector x may include features that correspond to a larger segment of time (e.g. S). Such features may include a relatively global characteristic of the game, such as the current game status.

Following models' construction in 545 and 565, the models' parameters, θ_{A} and θ_{B}, are estimated in steps 550 and 570 using the training datasets of team-A and team-B, respectively. As mentioned above, a training dataset comprises of examples of a model's variables: {xₖ}ₖ₌ⱼ^{j-m} for which the future event y is known. For instance, training sets, with respect to each team, may include N pairs of labeled data: {xᵢ,yᵢ}ᵢ₌₁^{N}.

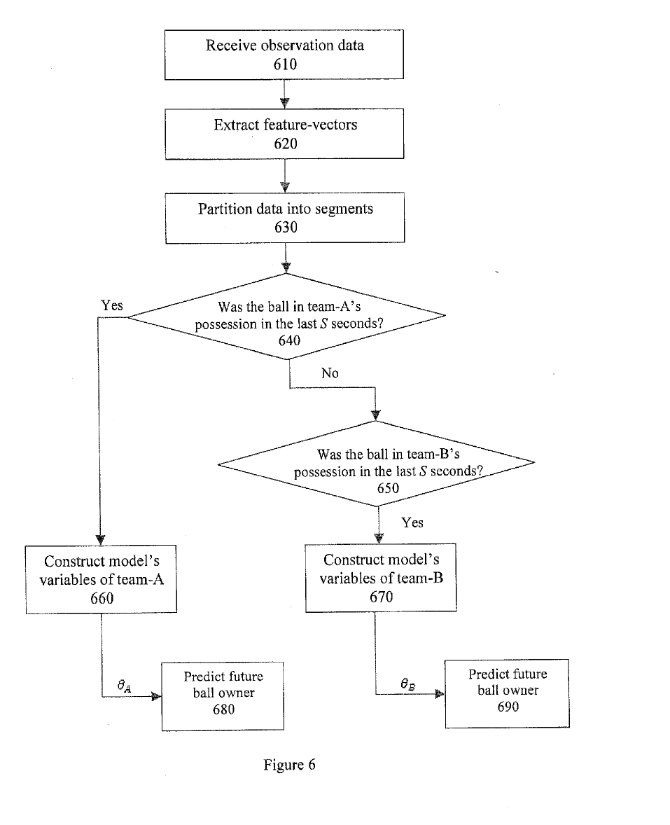

FIG. 6, demonstrates the process of predicting a future event as employed for the application of future ball possession prediction in a soccer game. As mentioned above, this process is also referred to as the method's testing-phase, following the training-phase through which the model parameters θ_{A} and θ_{B} are estimated. In both training-phase and testing-phase the steps of receiving observation data, 510 and 610, extracting feature-vectors, 520 and 620, and partitioning game data into segments, 530 and 630, are similar as described above. When in an operative mode, if the ball has been in team-A's possession for a continuous time segment 640 (e.g. the last S sec) construction of team-A model's variables takes place in step 660. Otherwise, if the ball has been in team-B's possession for a continuous time segment 650 (e.g. the last S sec) construction of team-B model's variables takes place in step 670. Next in the process, prediction is carried out in steps 680 and 690 using the trained parameter vectors θ_{A} and θ_{B} respectively.

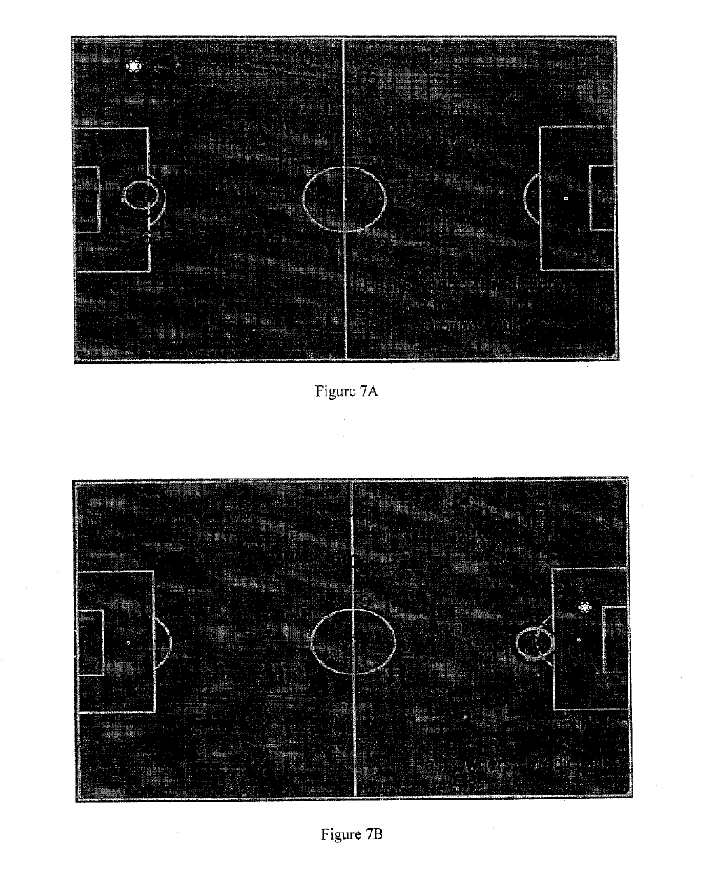

FIGS. 7A and 7B illustrate two cases of ball ownership prediction using a four-order (m=4) model 200. For example, in FIG. 7A at time tⱼ the four hidden states are: hⱼ=9, hⱼ₋₁=9, hⱼ₋₂=5, and hⱼ₋₃=4. The predicted owner of the ball turned out to be player 11, i.e. y=11. Similarly, in FIG. 7B at time tⱼ the four hidden states are: hⱼ=, hⱼ₋₁=7, hⱼ₋₂=5, and hⱼ₋ [symbol] =4. The predicted owner of the ball, in this case, is player 3, i.e. y=3

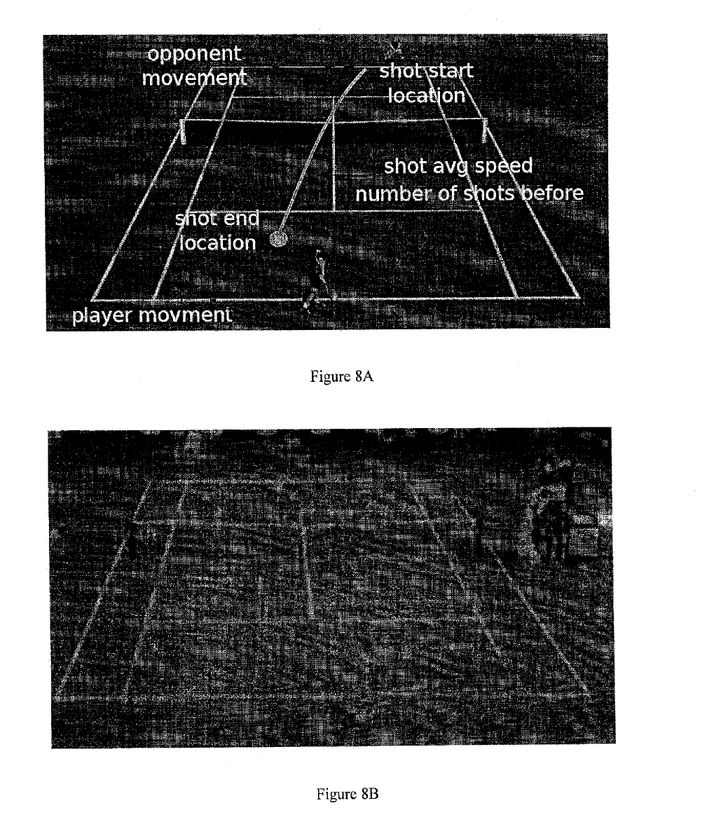

Embodiments of the current invention may also be employed for predicting the location of the next tennis shot. As illustrated in FIG. 8A, various features indicative of the likely shot location may be used to construct the feature-vector x. For example, information such as the shot start location, the opponent recent movements, recent shots average speed, and the player's recent movements may influence the hidden states h and the future event y in the a-HCRF model 200. These features may be extracted, for instance, from positional data captured by a camera system 420 designed to detect and track the location of the players and of the ball based on their image projections in the video. The set of variables h and Y, in this case, are discretized shot locations. FIG. 8B demonstrates one possible quantization scheme wherein the court in the player's side is divided into nine bins (inner zones). Thus, a hidden state hⱼ is defined as a variable that can take one of nine possible values, each representing a particular zone of a shot location occurring at time tⱼ. Hence, hⱼε [symbol] where [symbol] =(1,2,3, . . . ,9). Similarly, the future event (i.e. next shot) y is defined as a variable that can take ten possible values. The first nine values are each respective to one possible inner-zone and the tenth value is respective to a shot location outside the inner area, labeled as outer-zone (OZ). Hence, yεy where y={1,2,3, . . . , 9, OZ}.

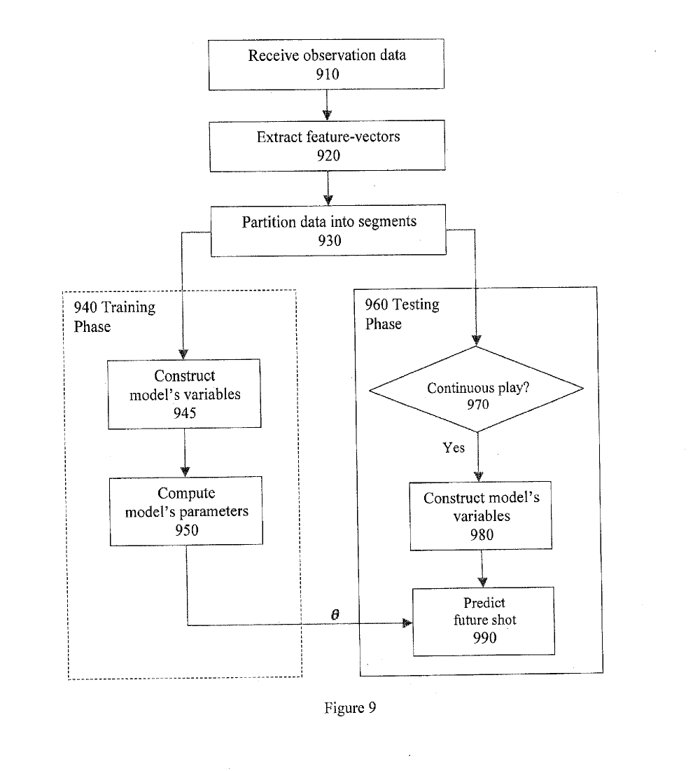

Similar to predicting the ball's ownership, predicting the location of the next shot in tennis (i.e. future game-event) may be carried out by employing a training and a testing processes, as shown in FIG. 9. As in steps 610-630 described above, an a-HCRF predictor starts with receiving the observation data 910, extracting feature vectors 920, and partitioning data into continuous play segments 930. As in 540 and 560, the training process in 940 is typically performed offline and operates on continuous segments of the play. Thus, the training-phase includes a step of constructing the a-HCRF model's variables 945 followed by estimating the model's optimal parameter vector θ 950. In its testing-phase 960, the predictor proceeds with prediction once a continuous play segment (e.g. S second length) is available 970. The model variables are constructed in step 980. As before, constructing the model's variables (in both 945 and 980) may include aggregating observation data within a window time ω (between tⱼ and t [symbol] j−ω). Given the a-HCRF model's variables and its parameter vector θ, prediction is carried out in step 990.

For both soccer and tennis embodiments described above, the a-HCRF models were trained based on data captured from games of which a team (or player) of interest played against various opponent teams (or players). In adversarial sports the behavior of the team of interest throughout the match depends on the team it plays against. In practice, though, training a probabilistic model for each pair of specific teams (or players) is challenging as not enough data is available for training. Thus, embodiments of this invention employ model adaptation, where two models are combined. The first model is the one that was trained using data from all games including the team (or players) of interest, namely Generic Behavior Model (GBM). The second model is the one that was trained using data from all games including the team (or players) of interest playing against a specific opposition, namely Opposition Specific Model (OSM). The GBM and OSM models may be combined to improve the predictive capability of each model when used independently. Fusion, then, may be done at different levels. For example, the feature-vectors or the parameter-vectors of each model may be combined. Alternatively, the output of the GBM's and the OSM's predictors may be combined, for instance, by the linear combination:

P_{comb}=w₁·_{PGBM}+w₂·P_{OSM}, (10)

where wᵢ≧0, t=1,2 and w₁+w_{z}=1. The wᵢ value may be estimated through optimization process wherein the optimal wt minimizes the prediction error (or maximizes the prediction rate).

Myriad applications may benefit from the future event prediction method provided by embodiments of this invention. For example, knowledge of the next shot's location in a tennis game may be used to assist automatic steering of a measurement device (e.g. a broadcast camera). Similarly, knowing the position or identity of the next player to own the ball in a soccer game may be used to insert graphical highlights into a video stream capturing the game activities. Such highlights may include graphical overlays containing information related to the future owner of the ball (i.e. the predicted future event).

Although embodiments of this invention have been described following certain structures or methodologies, it is to be understood that embodiments of this invention defined in the appended claims are not limited by the certain structures or methodologies. Rather, the certain structures or methodologies are disclosed as exemplary implementation modes of the claimed invention. Modifications may be devised by those skilled in the art without departing from the spirit or scope of the present invention.

What is claimed is:

1. A future event prediction method being executed by at least one processor, comprising:
capturing spatiotemporal data pertaining to activities wherein the activities include a plurality of events; and
employing an augmented hidden conditional random field (a-HCRF) predictor to generate a future event prediction based on a parameter-vector input, hidden states, and the spatiotemporal data.

2. The method of claim 1, wherein employing the a-HCRF predictor further includes operating on a potential function, the potential function comprising:
a first term reflecting the compatibility between the hidden states and the spatiotemporal data;
a second term reflecting the compatibility between the future event and the hidden states;
a third term reflecting the compatibility between the future event and a pair of connected hidden states; and
a fourth term reflecting the compatibility between the future event and the spatiotemporal data.

3. The method of claim 1, further comprising:
computing the parameter-vector input based on a first training dataset.

4. The method of claim 3, further comprising:
computing the parameter-vector input based on a second training dataset.

5. The method of claim 1, wherein:
events, from the plurality of events, occur in a continuous temporal sequence; and
each event, from the plurality of events, is associated with a subset of spatiotemporal data captured within a temporal window relative to the each event's temporal position in the continuous temporal sequence.

6. The method of claim 1, wherein:
capturing spatiotemporal data further includes extracting a feature-vector from the spatiotemporal data; and
employing the a-HCRF predictor further includes operating on the feature-vector.

7. The method of claim 1, wherein the activities are team-games, the plurality of events is a plurality of game-events occurring at current and past times, and the future event is a game-event occurring at a future time.

8. The method of claim 7, wherein the team-games are one of a football, a soccer, a basketball, a hockey, a tennis, a baseball, a lacrosse, a cricket, and a softball game, and the game-events are one of an ownership of a playing object and a location of the playing object.

9. The method of claim 1, wherein the future event prediction is used to control a measurement device capturing part of the spatiotemporal data pertaining to the activities.

10. The method of claim 1, wherein the future event prediction is used to insert a graphic into a video stream capturing the activities.

11. A future event prediction system, comprising:
a capturing system configured to capture spatiotemporal data pertaining to activities wherein the activities include a plurality of events; and
an augmented hidden conditional random field (a-HCRF) predictor configured to generate a future event prediction based on a parameter-vector input, hidden states, and the spatiotemporal data.

12. The system of claim 11, wherein the a-HCRF predictor operates on a potential function, the potential function comprising:
a first term reflecting the compatibility between the hidden states and the spatiotemporal data;
a second term reflecting the compatibility between the future event and the hidden states;
a third term reflecting the compatibility between the future event and a pair of connected hidden states; and
a fourth term reflecting the compatibility between the future event and the spatiotemporal data.

13. The system of claim 11, wherein the a-HCRF predictor is configured to compute the parameter-vector input based on a first training dataset.

14. The system of claim 13, wherein the a-HCRF predictor is configured to compute the parameter-vector input based on a second training dataset.

15. The system of claim 11, wherein
events, from the plurality of events, occur in a continuous temporal sequence; and
each event, from the plurality of events, is associated with a subset of spatiotemporal data captured within a temporal window relative to the event's temporal position in the continuous temporal sequence.

16. The system of claim 11, wherein
the capturing system is further configured to extract a feature-vector from the spatiotemporal data; and
the a-HCRF predictor is further configured to operate on the feature-vector.

17. The system of claim 11, wherein the activities are team-games, the plurality of events is a plurality of game-events occurring at current and past times, and the future event is a game-event occurring at a future time.

18. The system of claim 17, wherein the team-games are one of a football, a soccer, a basketball, a hockey, a tennis, a baseball, a lacrosse, a cricket, and a softball game, and the game-events are one of an ownership of a playing object and a location of the playing object.

19. The system of claim 11, wherein the future event prediction is used to control a measurement device capturing part of the spatiotemporal data pertaining to the activities.

20. The system of claim 11, wherein the future event prediction is used to insert a graphic into a video stream capturing the activities.

21. A future event prediction system, comprising:
a processor configured to execute a future event prediction algorithm including a graph; and
a memory configured to store the future event prediction algorithm, wherein: the graph is comprised of nodes associated with random variables, the nodes connected by edges if their associated random variables are statistically dependent, the nodes including:
a first node associated with random variables corresponding to a future event state,
a second node associated with random variables corresponding to spatiotemporal input data,
a first group of nodes, each node therein associated with random variables corresponding to a subset of the spatiotemporal input data,
a second group of nodes, each node therein associated with random variables corresponding to a hidden-state; wherein:
the edges connect the first node with the second node, the first node with the second group of nodes, and the first group of nodes with the second group of nodes.

22. A non-transitory computer-readable storage medium storing a set of instructions that is executable by a processor, the set of instructions, when executed by the processor, causing the processor to perform operations comprising:
capturing spatiotemporal data pertaining to activities wherein the activities include a plurality of events;
employing an augmented hidden conditional random field (a-HCRF) predictor in a training-phase to compute a parameter-vector based on a training dataset; and
employing a-HCRF predictor in a testing-phase to generate a future event prediction based on the parameter-vector, hidden states, and the spatiotemporal data.
